(19) United States
(12) Patent Application Publication
(10) Pub. No.: US 2014/0025435 A1
(43) Pub. Date: Jan. 23, 2014

(54) System and Methods for Brute Force Traversal

(71) Applicant: Vendavo, Inc., Mountain View, CA (US)

(72) Inventors: Rajeev Bansal, Fremont, CA (US); Niel Esary, Mountain View, CA (US)

(73) Assignee: Vendavo, Inc., Mountain View, CA (US)

(21) Appl. No.: 13/946,995

(22) Filed: Jul. 19, 2013

Related U.S. Application Data
(63) Continuation-in-part of application No. 13/907,860, filed on Jun. 1, 2013.
Application No. 13/907,860 is a continuation of application No. 10/857,262, filed on May 28, 2004, now Pat. No. 8,458,060.

(51) Int. Cl. G06Q 30/02

(52) U.S. Cl. CPC G06Q 30/0206
USPC 705/7.35

(57) ABSTRACT

The present invention relates to systems and methods for brute force traversal of a transaction data set. In some embodiments, the systems and methods for brute force traversal receive a data dictionary that describes dimensions of transactions and hierarchical relationships between the dimensions. The transactions are then segmented according to a key system of possible combinations of segments. Statistical metrics of decision variables are calculated within each segment. Further, the ancestor segments for each segment are identified. The statistical metrics of each segment are compared to each of its ancestor segment's statistical metrics in order to identify outliers.

### CROSS REFERENCE TO RELATED APPLICATIONS

This application is a continuation-in-part of U.S. patent application Ser. No. 13/907,860, filed on Jun. 1, 2013, by Niel Esary et al., entitled “System and Method for Organizing Price Modeling Data using Hierarchically Organized Portfolios”, currently pending, which is a continuation of U.S. patent application Ser. No. 10/857,262, filed on May 28, 2004, by Niel Esary et al., entitled “System and Method for Organizing Price Modeling Data using Hierarchically Organized Portfolios”, now U.S. Pat. No. 8,458,060, which applications are incorporated herein in their entirety by this reference.

This application is related to co-pending application Ser. No. ______, filed Jul. 19, 2013, by Rajeev Bansal et al., entitled “System and Methods for Comparing Segments” which application is incorporated herein in its entirety by this reference.

### BACKGROUND OF THE INVENTION

The present invention relates to business to business market price control and management systems. More particularly, the present invention relates to systems and methods for brute force traversal of transactions in order to enable segmented analysis.

There are major challenges in business to business (hereinafter “B2B”) markets which hinder the effectiveness of classical approaches to analyzing pricing impacts and thus optimization or guidance of pricing strategies. Classical approaches to price optimization typically rely upon databases of extensive transaction data which may then be modeled for demand. The effectiveness of classical price optimization approaches depends upon a rich transaction history where prices have changed, and consumer reactions to these price changes are recorded. Thus, classical price optimization approaches work best where there is a wide customer base and many products, such as in Business to Consumer (hereinafter “B2C”) settings.

Unlike B2C environments, in B2B markets a small number of customers represent the lion's share of the business. Managing the prices of these key customers is where most of the pricing opportunity lies.

One approach to analyzing B2B markets for the generation of pricing opportunity insights is the utilization of segmenting processes. As is known in the art, segmenting transactions, products or customers (or some combination thereof) is a useful way of grouping data by common traits. These segments thereby enabling modeling of behaviors and/or outcomes. Traditional transaction analysis in the B2B market typically focuses on a specific segment in which a domain expert expects to find evidence of interesting behavior that can be actionable in terms of policy by the company to improve returns on sales.

More recently, more advanced analysis techniques will use top-down decision tree analysis to identify sets of transactions that behave similarly (decision tree clustering), even if their characteristics are not exact matches. These groups of transactions are then analyzed as if they formed one single segment in hopes of identifying actionable policy by to improve returns.

Unfortunately, none of the prior techniques of segment based analysis goes beyond single segment or clustered analysis and examines the entire space of all segments. Such systems would be able to identify all segments with actionable policy which may be overlooked using current techniques of single or clustered segment analysis. Further, a whole space approach could also compare segments in a manner that is currently unavailable using traditional techniques.

As such, an urgent need exists for a system and method for whole space segment analysis. Such an analysis would enable the identification of a more complete set of actionable policy opportunities. These opportunities can thus be leveraged to enhance revenues and drive profits.

### SUMMARY OF THE INVENTION

The present invention discloses business to business market price control and management systems. More particularly, the present invention teaches systems and methods for brute force traversal of a transaction data set, useful in association with an integrated price management system.

In some embodiments, the systems and methods for brute force traversal receive a data dictionary that describes dimensions of transactions and hierarchical relationships between the dimensions. Next, possible combinations of transactions may be generated. A segmentation key for each of the possible combinations is also generated. The transactions are then segmented according to the key system.

Statistical metrics of decision variables are calculated within each segment. The statistical metrics include a minimum, maximum and threshold for the decision variables. Further, the ancestor segments for each segment are identified. The ancestor segments are each segment that exists in a higher level of the hierarchical relationship, and can be defined to preclude redundant hierarchical levels. The statistical metrics of each segment are compared to each of its ancestor segment's statistical metrics in order to identify outliers. The outliers are identified where the threshold for the ancestor segment is below the minimum, or above the maximum, for the segment. In some cases, the threshold is approximately the 50^{th} percentile for the segment, and the maximum is approximately the 90^{th} percentile for the segment.

A margin percentage for each transaction may also be generated. Due to the size of the dataset, the segmenting and the calculating statistical metrics are performed in parallel. Likewise, an estimate for the time to first results and time to completion can also be generated.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simple graphical representation of an enterprise level pricing environment, in accordance with some embodiments;

FIG. 2 is a simplified graphical representation of a price modeling environment where an embodiment of the present invention may be utilized;

FIG. 3 is a simplified graphical representation of dataflow within a price modeling environment where an embodiment of the present invention may be utilized;

FIG. 4 is a flow chart illustrating a technique for quote generation, in accordance with some embodiments;

FIG. 5 is a schematic of a portfolio hierarchy, in accordance with some embodiments;

FIG. 6 is an example block diagram illustrating a system for brute force traversal of a transaction dataset and segment comparison, in accordance with some embodiments;

FIG. 7 is a more detailed example block diagram illustrating the brute force traversal engine, in accordance with some embodiments;

FIG. 8 is a more detailed example block diagram illustrating the segment comparer, in accordance with some embodiments;

FIG. 9 is a flow chart illustrating an exemplary method for performing automated recoverable margin analysis, in accordance with some embodiments;

FIG. 10 is a flow chart illustrating an exemplary method for the step of brute force traversal of FIG. 9;

FIG. 11 is a flow chart illustrating an exemplary method for the step of analyzing segment comparisons of FIG. 9;

FIGS. 12A and 12B are illustrative examples of characteristic hierarchical tree structures;

FIG. 13 is an illustrative example of a set of transaction records;

FIG. 14 is an illustrative example of the set of transaction records analyzed for percent margin and an applicable data dictionary;

FIGS. 15A and 15B are illustrative examples of the set of transaction records broken down by segment key;

FIG. 16 is an illustrative example of a table of the segment keys and their accompanying statistics;

FIG. 17 is an illustrative example of the segment keys and their accompanying statistics with ancestor listings;

FIG. 18 is an illustrative example of the child and ancestor key;

FIG. 19 is an illustrative example of the segment keys and their accompanying statistics with ancestor listings expanded out;

FIG. 20 is an illustrative example of each segment compared against its ancestor; and

FIGS. 21A and 21B provide an illustration of a computer system capable of embodying the disclosed invention.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

As previously discussed, traditional techniques used to identify policy opportunities within a business to business (B2B) price management system typically focuses on a specific segment in which a domain expert expects to find evidence of interesting behavior that can be actionable in terms of policy by the company to improve returns on sales, or a cluster of segments identified by a decision tree crawling algorithm. While such techniques bring some degree of benefit, many opportunities may be lost by not analyzing the entire set of segments. Further, such methodologies lack the ability to compare segments in a meaningful fashion.

In order to address these deficiencies, a system for automated recoverable margin analysis is presented, which relies upon brute force traversal of the transaction records. This system enables the analysis of very large numbers of segments, including inter-segment analysis and intra-segment analysis (as well as the traditional simple segment analysis).

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. PRICE MANAGEMENT SYSTEM

Brute force traversal for automated recoverable margin analysis has particular benefit in the B2B environment, and in conjunction with a pricing management system which is capable of directing negotiations through policy setting. Thus, a brief overview of such a pricing management system will be provided in order to properly orient the reader.

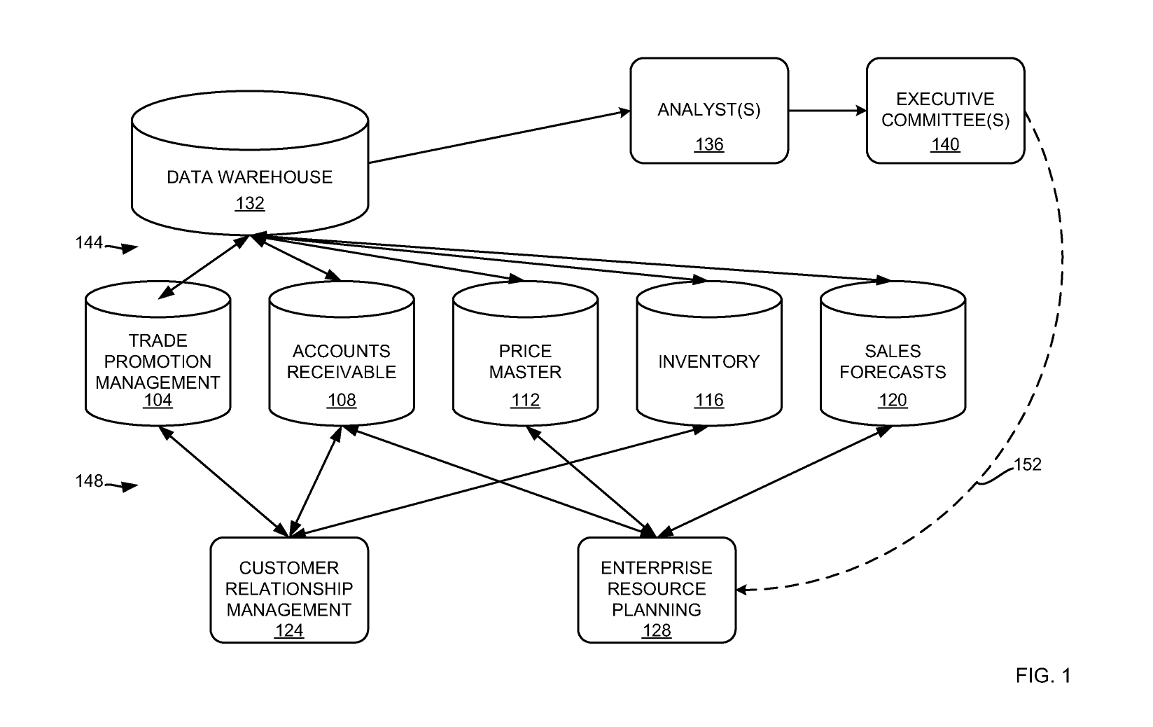

To facilitate discussion, FIG. 1 is a simplified graphical representation of an enterprise pricing environment. Several example databases (104-120) are illustrated to represent the various sources of working data. These might include, for example, Trade Promotion Management (TPM) 104, Accounts Receivable (AR) 108, Price Master (PM) 112, Inventory 116, and Sales Forecasts 120. The data in those repositories may be utilized on an ad hoc basis by Customer Relationship Management (CRM) 124, and Enterprise Resource Planning (ERP) 128 entities to produce and post sales transactions. The various connections 148 established between the repositories and the entities may supply information such as price lists as well as gather information such as invoices, rebates, freight, and cost information.

The wealth of information contained in the various databases (104-120) however, is not “readable” by executive management teams due in part to accessibility and in part to volume. That is, even though the data in the various repositories may be related through a Relational Database Management System (RDMS), the task of gathering data from disparate sources can be complex or impossible depending on the organization and integration of legacy systems upon which these systems may be created. In one instance, all of the various sources may be linked to a Data Warehouse 132 by various connections 144. Typically, the data from the various sources is aggregated to reduce it to a manageable or human comprehensible size. Thus, price lists may contain average prices over some selected temporal interval. In this manner, the data may be reduced. However, with data reduction, individual transactions may be lost. Thus, CRM 124 and ERP 128 connections to an aggregated data source may not be viable

Analysts 136, on the other hand, may benefit from the aggregated data from a data warehouse. Thus, an analyst 136 may compare average pricing across several regions within a desired temporal interval and then condense that analysis into a report to an executive committee 140. An executive committee 140 may then, in turn, develop policies directed toward price structuring based on the analysis returned from an analyst 136. Those policies may then be returned to CRM 124 and ERP 128 entities to guide pricing activities via some communication channel 152 as determined by a particular enterprise.

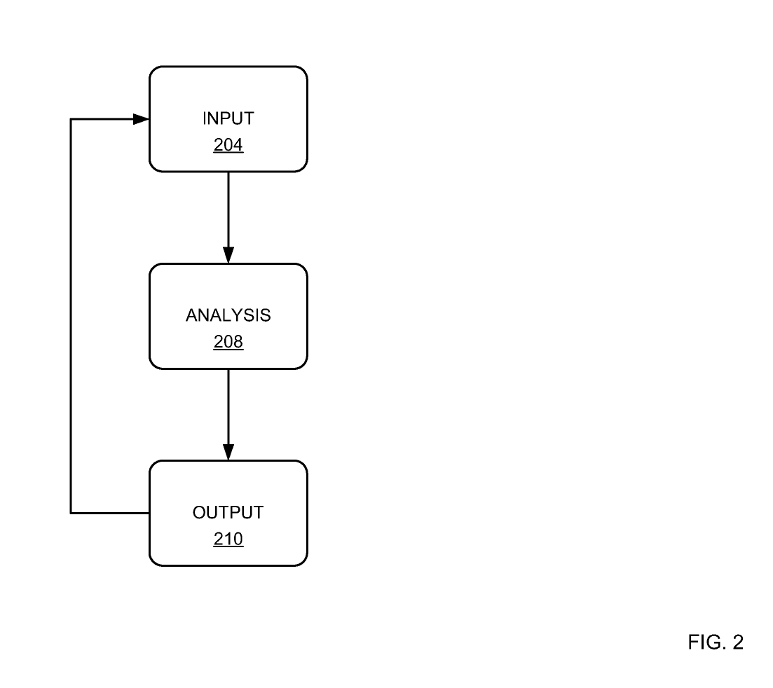

FIG. 2 illustrates a simplified graphical representation of a closed-loop system. As can be appreciated closed-loop systems are common in, for example, the mechanical and electromechanical arts. In general, a closed-loop system is a control system in which the output is continuously modified by feedback from the environment. As illustrated, for example, an input at a step 204 would be a feedback element. Inputs may be any desired indicator or metric that is measurable in some way. For example, an input may be a temperature reading taken from a thermocouple sensor. The input is then analyzed at a step 208. Many types of analysis are available depending on the intended use. A simple comparison against a set value is one example. Another example might include advanced statistical analysis where appropriate. Thus, as can be appreciated, analysis in closed-loop systems may be highly complex.

An output is generated next at a step 210 based on the analysis of step 208. An output may be any operation that is intended to affect a condition of the desired system. In the above thermocouple example, a temperature may be read (e.g., input); compared against a set temperature (analysis); and affected by turning on or off a heating element depending on the comparison (output). Finally, the system loops back to the input and continues until the system, or a user terminates the process.

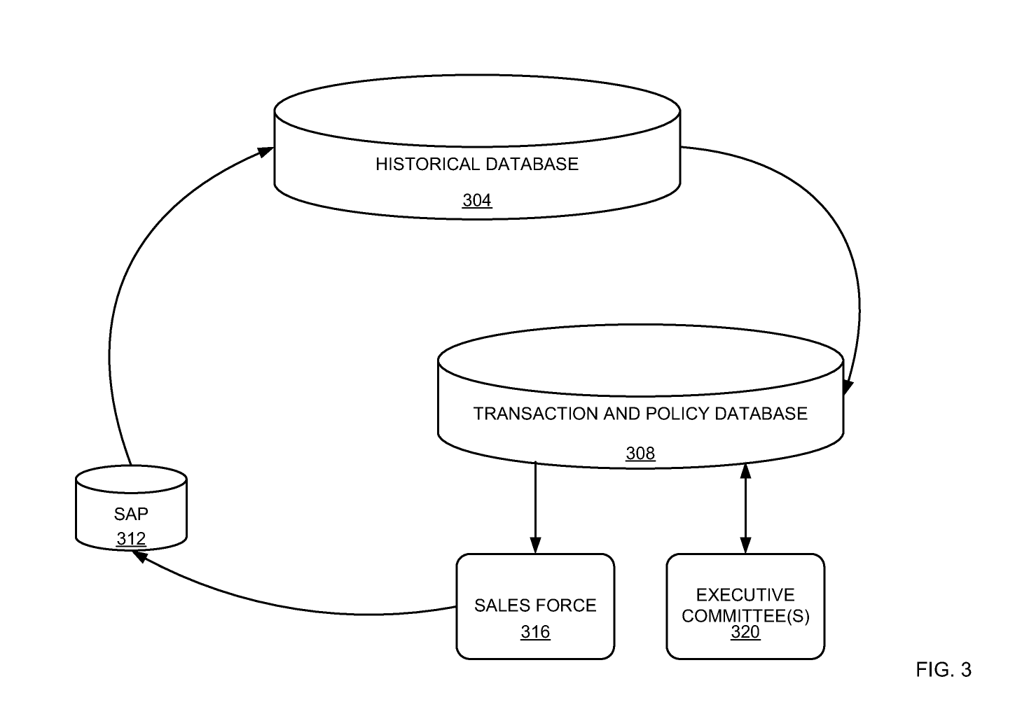

As pertains to the present disclosure, FIG. 3 is a simplified graphical representation of a closed-loop implementation of an embodiment of the present invention in a price modeling environment. At a first step 304, data is input into a historical database. A historical database, under the present invention may contain any of a number of inputs. In one embodiment of the present invention, a historical database may include sales transactions. In other embodiments of the present invention, a historical database may include waterfall records. A group of associated waterfall records may be defined as a price adjustment continuum. For example, in a transactional sales environment, an invoice price from a transaction may be affected by a rebate such that: invoice price=retail price−rebate. In this example, one waterfall record is a rebate. The rebate represents a price adjustment to the retail price that affects the invoice price. Rebate may also be thought of as a “leakage” in that the profitability of a sale is indirectly proportional to the amount of leakage in a given system. In a price modeling environment, metrics, like rebates for example, that may affect the profitability of a transaction, may be stored at a transaction level in a historical database. Many waterfall records may exist for a transaction like, for example: industry adjustments, sales discretion, shipping charges, shipping allowances, late payment costs, extended terms costs, consignment costs, returns, packaging costs, base material costs, additive costs, processing costs, variable costs, shortfalls, overages, and the like.

The analysis of the data may then automatically generate a transaction and policy database 308. For example, analysis of a selected group of transactions residing in a historical database may generate a policy that requires or suggests a rebate for any sale in a given region. In this example, some kind of logical conclusion or best guess forecast may have determined that a rebate in a given region tends to stimulate more and better sales. This policy is thus guided by historical sales transactions over a desired metric—in this case, sales by region. The policy may then be used to generate logic that will then generate a transaction item.

In this manner, a price list of one or many items reflecting a calculated rebate may be automatically conformed to a given policy and stored for use by a sales force, for example. In some embodiments, policies are derived strictly from historical data. In other embodiments, policies may be generated ad hoc in order to test effects on pricing based hypothetical scenarios. In still other examples, executive committee(s) 320, who implements policies, may manually enter any number of policies relevant to a going concern. In this manner, policies may be both automatically and manually generated and introduced into the system.

After transactions are generated based on policies, the transactional portion of the database may be used to generate sales quotes by a sales force 316 in SAP 312, for example. SAP may then generate a sales invoice which may then, in turn, be used to further populate a historical database 304, which closes the loop. In some embodiments, sales invoices may be constrained to sales quotes generated by a transaction and policy database. That is, as an example, a sales quote formulated by a sales force 316 may require one or several levels of approval based on variance (or some other criteria) from policies stored in a transaction and policy database 308. In other embodiments, sales invoices are not constrained to sales quotes generated by a transaction and policy database.

By applying closed-loop logic to a price modeling environment, pricing advantages may be achieved. In one example, workflow efficiencies may be realized where “successful” sales are tracked and policies supporting activities corresponding to the “successful” sales are implemented. The determination of “successful” in terms of a sale may be defined in any of a number of ways including, for example, increased profitability or volume. In this manner, an enterprise allows real market results to drive sales' policy rather than basing policy solely on theoretical abstractions. In other examples, hypothetical changes to policies may be tested. Thus, for example, a suggested policy requiring a rebate for any sale over $1000.00 may be implemented to test the effect on overall margins without actually modifying existing policies. In that case, a suggested policy change may reveal insight into future sales transactions that result in no net effect on margins, or may reveal insight into areas that require further adjustment to preserve or increase margins.

Another advantage to the system is that policy may flow directly from input data in an efficient manner. Individual spreadsheets and analysis typically used in price modeling may no longer be necessary. Instead, executive committees have access to real-time data that is continually updated to reflect current sales and sales practices. Response to a given policy may be seen or inferred directly from a historical database and implemented directly on a transaction and policy database. Thus, temporal efficiencies are achieved.

In still other examples, a closed-loop system may be used to evaluate individual or grouped transactions as, for example, in a deal making context. That is, a salesperson may generate a quote for a given customer and submit that quote for comparison against a policy formulated transaction in a transaction and policy database. A comparison may reveal some basis upon which a quote may represent a profitable deal. In some embodiments, a deal indicator may be generated. A deal indicator may be a ratio of the quote against a composite index that generates a value between 0 and 1 corresponding to profitability. In this example, a ratio returning unity (i.e., 1) indicates a deal is in conformance with established policy. It may be appreciated that a ratio may be defined in any of a number of manners without departing from the present invention.

In other embodiments, a deal suggestion may be generated. A deal suggestion may provide a range of acceptable (i.e., profitable) pricing based on quote parameters. Thus, a quote having deal specific set parameters like, for example, a fixed shipping price may return a range of allowable rebates or a range of allowable sales discretion that account for a fixed shipping input. In still other embodiments, deal guidance may be provided. Deal guidance provides non-numeric suggestion for a given quote. Thus, deal guidance might, for example, return “acceptable deal,” or “unacceptable deal” in response to a given quote. Policy considerations underlie deal indicators, deal suggestions, and deal guidance. Availability of these comparisons allows a user to select a comparison best fitted to their sales techniques and preferences which may result in sales efficiencies.

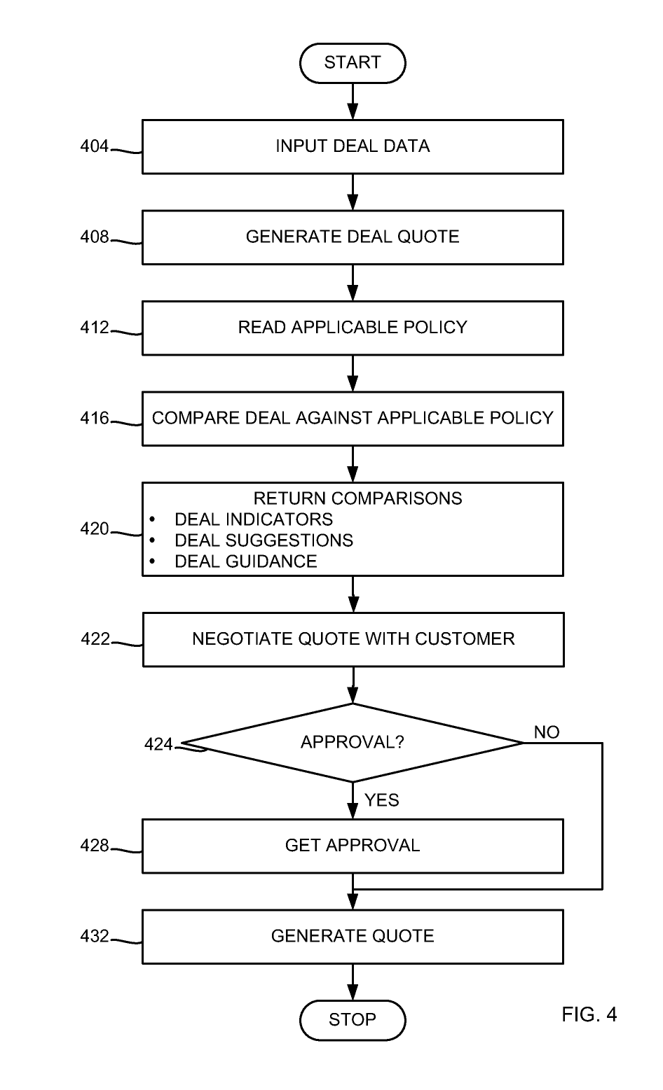

An example embodiment of the present invention using a closed-loop system is next presented. FIG. 4 is a flow chart of an embodiment of the present invention based on a closed-loop system. At a first step, 404 deal data is input into the system. Deal data may include any of a number of inputs like, for example, shipping costs, rebate, discounts, and the like. A deal quote may then be generated at a step 408 calculated from the deal data input at a step 404 and further including any missing field items based on policy considerations. Applicable policy is then read at a step 412. Applicable policy may be automatically selected or user selected by a particular metric. For example, policy may be utilized based on global metrics or may be delimited by region.

After the applicable policy is read at a step 412, a deal quote may then be compared against applicable policy at a step 416. As noted above, a comparison may reveal some basis upon which a quote may represent a profitable deal. Comparisons are then returned for review by a user at a step 420. As noted above, comparisons may include deal indicators, deal suggestions, and deal guidance. An advantage of returning a comparison is that a complex analysis may be reduced to a readily ascertainable form. In this case, a deal indicator may return a ratio; a deal suggestion may return an acceptable range of values; and deal guidance may return a non-numeric suggestion for a given deal. Thus, a deal maker may determine, at a glance, the acceptability based on policy of a given quote.

Once comparisons are returned at a step 420, a quote may be negotiated at a step 422 that may or may not incorporate any or all of those corresponding comparisons. In this manner, a salesperson negotiating a deal may flexibly structure a deal with confidence that the deal may be constrained to comparison parameters resulting in a profitable deal for an enterprise. In one embodiment, entering a negotiated transaction initiates a recalculation of comparisons. Thus, a deal maker may view real-time changes to a deal structure as a deal is being formed. This feature is particularly useful in that final negotiating point parameters may be expanded or contracted as a deal progresses providing a deal maker with an increasingly better defined negotiating position.

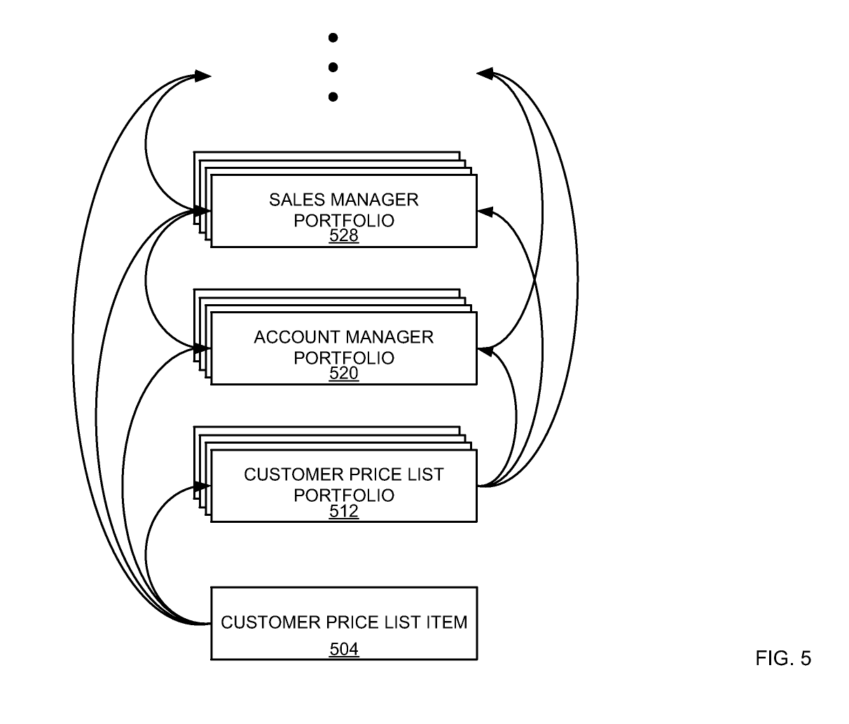

After a quote negotiation is complete at a step 422, the method determines whether approval is needed at a step 424. Approval, in this context, may be coupled with a portfolio manager. A portfolio manager may be utilized in an embodiment of the present invention to efficiently expedite approval of pending deals. Approval may include one or more levels depending on variance from an explicit or implicit policy. That is, for a particular deal that greatly varies from a policy, higher authority must approve of that particular deal. For example, a deal offering a rebate that is within policy limits may not require approval while a similar deal offering a rebate that falls outside of policy limits by, for example, 25% may need a sales manager or higher approval. Approval may be linked upward requiring executive officer approval in some cases. Portfolio management will be discussed in further detail below for FIG. 5.

If approval is needed, then a deal must be approved at a step 428. The method then continues at a step 432 to generate a quote. If approval at a step 428 is not needed, the method continues at a step 432 to generate a quote. As can be appreciated, a quote may then be used to generate an invoice. However, an invoice may or may not match the quote upon which it is based. Rather, an invoice represents an actual sale. It is the data from an actual sale that continues to populate a historical database. The method then ends.

As noted above, a portfolio manager may efficiently expedite approval of pending deals. Enterprises, as a practical reality, have a mix of “good” and “bad” deals—good deals being defined as profitable. Evaluating deals in isolation may not maximize profits at an enterprise level. For example, industries having large fixed costs may accept a number of high volume “bad” deals in order to capture a number of low volume “good” deals resulting in an overall profit. Industries evaluating deals in isolation may not realize this benefit and thus may not be able to survive. Portfolio organization, therefore, assists, for example, sales managers maximize profitability for an enterprise by allowing those managers to view enterprise level effects of a deal or groups of deals.

As seen in FIG. 5, a schematic representation of a portfolio hierarchy in accordance with an embodiment of the present invention is provided. A customer price list item 504 exists at the root of the hierarchy as an item. Each item may be configured to require approval on a pending deal, or may be configured to ignore approval on a pending deal. The customer price list item 504 may contain any of a number of descriptive and/or numeric terms such as price, description, availability, etc., for example. In one example, customer price list items 504 may be grouped into a portfolio known as customer price list portfolio 512.

Customer price list portfolios comprise customer price list items grouped according to a desired criteria or criterion. For example, price lists may be organized by cost, by type, by distributor, by region, by function, and by any other selected parameter. In this manner, approval, as an example, for a group of items—items under $1.00 for example—may be required or ignored. By grouping items, approval processes may be retained only for selected key products. In one embodiment, one or more criteria may be utilized to organize customer price list portfolio. It can further be appreciated that many other combinations of groupings for portfolios are possible. Thus, for example, a sales manager portfolio may comprise: customer price list items 504; customer price list portfolios 512; or account manager portfolios 520 as indicated by multiple arrows in FIG. 5. Further, in this example, a customer price list portfolio 512 is a static portfolio. That is, a static portfolio does not change according to a formula or algorithm. Rather, a static portfolio is entered and modified manually. It may be appreciated that most, if not all, portfolios may either be static portfolios or dynamic portfolios.

Customer price list portfolios 512 may then be organized to generate an account manager portfolio 520. Account manager portfolios 520, in this example, comprise customer price list portfolios 512 grouped according to a desired criteria or criterion. Typically, accounts may be organized by named companies or individuals. In addition to organizing accounts by name, accounts may be organized by approval. That is, all approval accounts may be managed singly or in group thus facilitating policy implementation. For example, an account portfolio may be organized such that any account having a 12-month history of on-time transactions no longer needs approval so that approval is ignored. In this way, an on-time account may accrue a benefit of an expedited approval thus making transactions more efficient for both the sales person and the account. Further, in this example, an account manager portfolio is of the type—static portfolio. As noted above, a static portfolio does not automatically change according to a formula or algorithm.

Account portfolios 520 may be further organized to generate sales manager portfolios 528. Sales manager portfolios 528, in this example, comprise account manager portfolios 520 grouped according to a desired criteria or criterion. Typically, sales manager portfolios may be organized by named individuals or groups of individuals. In addition to organizing sales manager portfolios by name, sales manager portfolios may be organized by approval. As noted above, approval based portfolios may be managed singly or in group thus facilitating policy implementation. For example, a sales manager portfolio may be organized such that sales people with seniority no longer need approval for deals under a capped amount. In this way, sales people with more experience benefit from an expedited approval process since presumably more experienced sales people have a deeper understanding of company policies and priorities. In addition, as new policy is generated, approvals may be reinstated as a training measure so that policies may more effectively be incorporated into a workflow. In this example, a sales manager portfolio 528 is of the type—dynamic portfolio. Dynamic portfolios may be generated according to formula or algorithm. For example, a sales manager portfolio may be generated for all sales associates whose total billing exceeds a desired dollar amount. In this way, managers may creatively and efficiently differentiate productive and unproductive sales associates and may further apply varying levels of approval.

### II. AUTOMATED RECOVERABLE MARGIN ANALYSIS

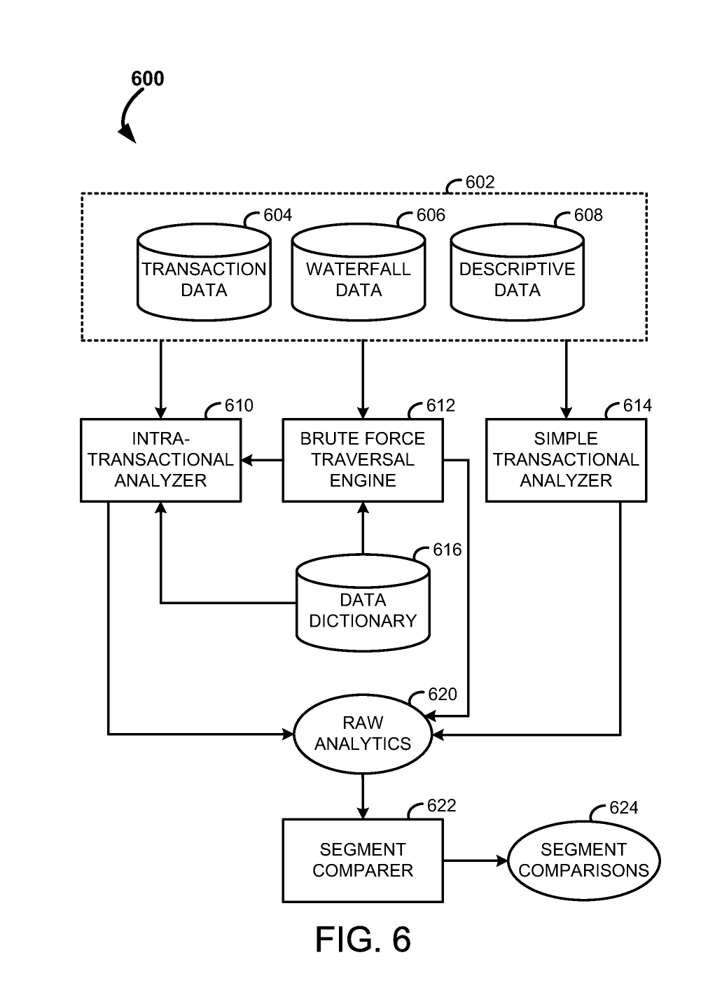

Now that the general structure of an example pricing management system has been discussed, attention will now be focused upon the systems for brute force traversal and segment comparison in order to perform automated recoverable margin analysis. To facilitate this discussion, attention is directed toward FIG. 6 where an example block diagram of the system 600 for brute force traversal of a transaction dataset and segment comparison is provided.

The brute force traversal methodology dispenses with single or clustered analysis and examines the entire space of all segments. It analyzes them all, thus finding any and all interesting segments for actionable policy change. Additionally, it can compare segments that are related, resulting in an even more powerful analysis to describe outliers and root causes of discovered behaviors. In some embodiments, brute force traversal does not actually traverse the entire inordinately large space, but rather only the locations within that space that contain data. The rest is empty and is of no interest. This insures that all possible segments are analyzed without traveling to segments of no interest.

In this example block diagram, a set of inputs 602 are provided to the various analyzers and the brute force traversal engine 612. The inputs 602 includes transaction data 604, waterfall data 606 and descriptive data 608. Transaction data provides a record of a history of transactions between a company and its customers. A transaction pricemart provides this data broken down with a waterfall detail and annotated with the characteristics of each sale. The characteristics of each sale are dimensional in nature, where each individual characteristic has a unique set of enumerated values, from which a single value will annotate any specific transaction for that characteristic. Examples of these characteristics might include Product, Customer, SalesRep, Region, etc. Some of these characteristics may form hierarchical relationships, such as Product Line, Product Family and Product. Together these dimensions form an inordinately large space defined by the intersection of all of these attributes. However, for any given pricemart, the area within this very large space that actually contains data is very small. These areas that contain data can be described as segments, groups of transactions with a subset of like characteristic values.

The inputs 602 may be utilized to perform three types of analysis: 1) simple transactional analysis, whose results can be derived from no input other than that available in a single transaction, 2) intra-transactional analysis whose results can be derived from no input other than that available in a single segment and 3) inter-transactional analysis is one whose results are derived through a comparison of two segments.

For the sake of simplicity, basic simple transactional analysis, by the simple transactional analyzer 618, will not be discussed in any further detail because such methods are known in the art. However segment inter-transactional and intra-transactional analysis requires segmentation prior to completion. For the purposes of this disclosure, a “segment” shall be defined as a group of transactions that have been gathered together because of common values among a subset of a transactions dimensions. The segments are generated by the brute force traversal engine 612 (as will be discussed in detail below), and the analysis on these segments is completed by the intra-transactional analyzer 610 and the brute force traversal engine 612 for inter-transactional analysis, respectively. Segment generation and analysis may also rely upon a data dictionary 616, which defines the dimensions of the input data and their hierarchical relationships.

The number of independent dimensions and hierarchical dimensions defines the number of ways in which the data can be segmented, or in terms of a more database driven lexicon, grouped-by. Therefore the total number of segments that can be generated is dependent on the number of different ways the transactions can be grouped and the number of groups formed by each grouping.

The result of the analysis may form a set of raw analytics 620, which by themselves may identify revenue generating opportunities. Further, these raw analytics 620 may be leveraged by a segment comparer 622 to generate segment comparisons 624 for further opportunity identification.

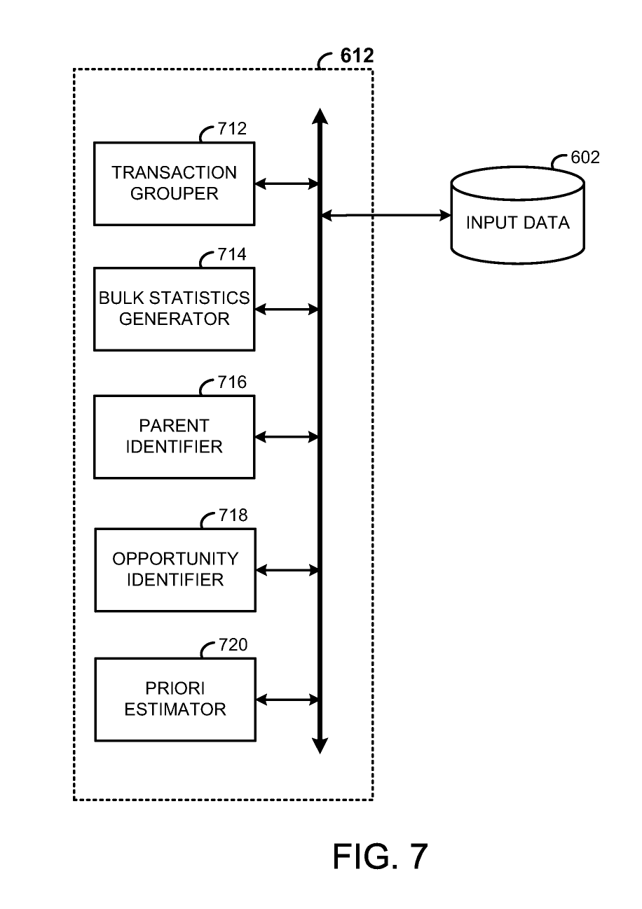

FIG. 7 is a more detailed example block diagram illustrating the brute force traversal engine 612. This engine is seen as consisting of a set of subsystems, each in communication with one another. These subsystems include a transaction grouper 712, a bulk statistics generator 714, a parent identifier 716, an opportunity identifier 718, and a priori estimator 720.

The transaction grouper 712 initially groups transactions by common characteristics, while the bulk statistics generator 714 generates segment statistics as the transactions are added to the segment grouping. Parents of the segment are identified by the parent identifier 716 by leveraging the data dictionary 616.

My comparing segment statistics to that of the parents, a set of opportunities is identified by the opportunity identifier 718. The priori estimator 720 generates an estimate of Time to First Result (TTFR) and Time to Last Result (TTLR).

Due to the fact that, when provided with a transactional data set, a very large number of segments is implied, embodiments of the brute force traversal engine 612 will traverse and analyze the entire space in a reasonable amount of time by traversing the space wisely, and be able to be notified of, and access, intermediate results for the segments already analyzed. This enables the engine to able to perform secondary analysis as the primary space is being traversed.

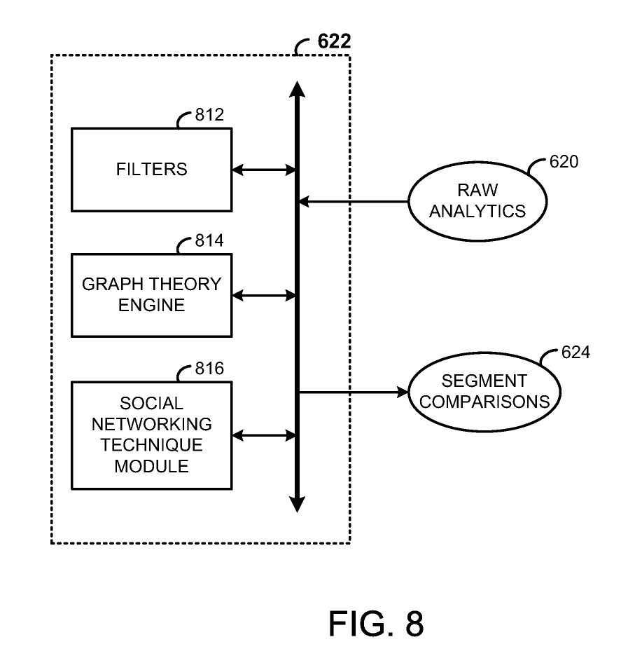

Moving on, FIG. 8 is a more detailed example block diagram illustrating the segment comparer 622, in accordance with some embodiments. This module includes three subsystems, including a set of filters 812, a graph theory engine 814, and a social networking technique module 816. This system enables the filtering of the raw analytics 620 to prune down the dataset to a reasonable base date set. This is then graphed using graph theory to connect the outputs. This provides a first order classification of segments into non-overlapping spaces. However, it is hard to describe these graphs in a meaningful way, as they are comprised of chains of related segments. The second pass then utilizes approaches found in Social Networking to find a central node to each graph and examine the most profitable comparisons connected to that node to describe the opportunity discovered in that graph. The output of the system is thus segment comparisons 624.

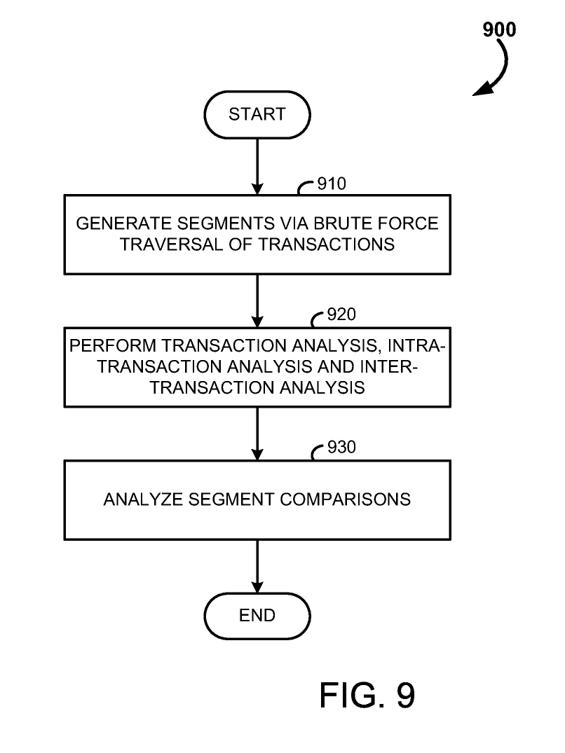

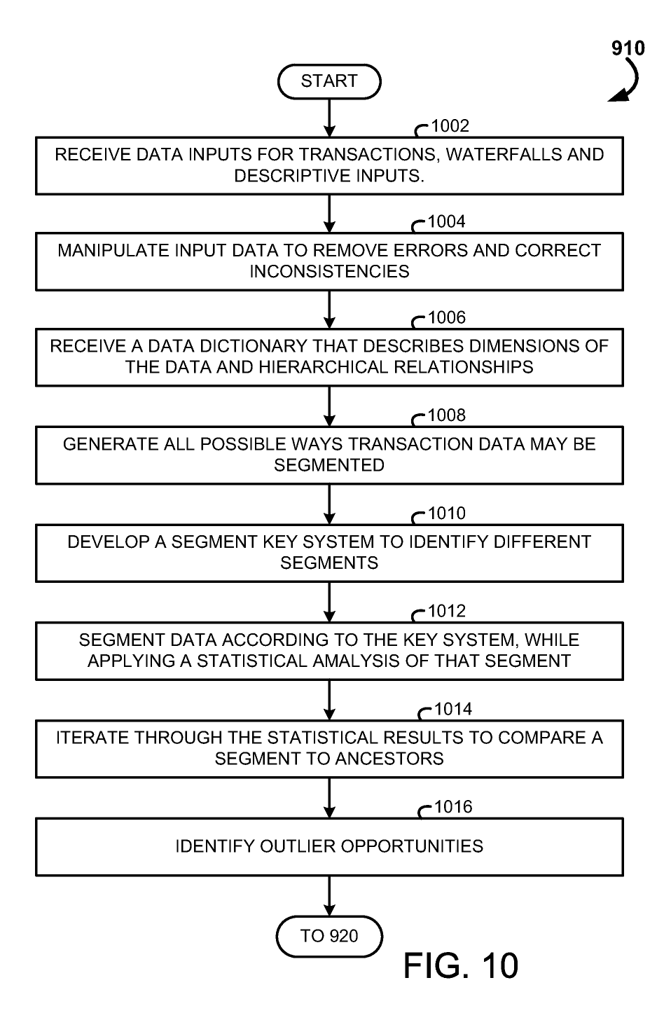

Continuing, FIG. 9 provides a flow chart 900 illustrating an exemplary method for performing automated recoverable margin analysis, in accordance with some embodiments. In this example process, the segments are first segmented via brute force traversal (at 910) in a process described in FIG. 10. This includes receiving data inputs (at 1002) for transactions, waterfalls and descriptive inputs. Often the inputs are arranged in a tabular data structure with each row being a transaction, and each column are one of the data types (i.e., transaction, waterfall or descriptive). Transactional data includes such data as transaction ids and dates specific to identify the transaction. Waterfall data describes a breakdown of the revenue generated by the transaction. It breaks down the revenue, costs and marginal difference between them. Columns containing descriptive data can each be thought of as a dimension, whose value annotates the transaction, identifying where it falls in a multi-dimensional space of the business done by the company. Examples of descriptive data would be the Customer, Region, Sales Rep, and Product. This data is mostly nominal, in that the value for each dimension can come from a list of distinct non-numeric values. Sometimes the data can be continuous real numbers as well, such as quantity.

The input data may then be manipulated (at 1004) to remove errors and correct inconsistencies. Additionally, it is often desirable to perform calculations or transformations in order for the input data to be readily consumable for downstream analysis. Examples of these transformation include calculating margin percentages for each transaction, adding year and quarter data, and the like.

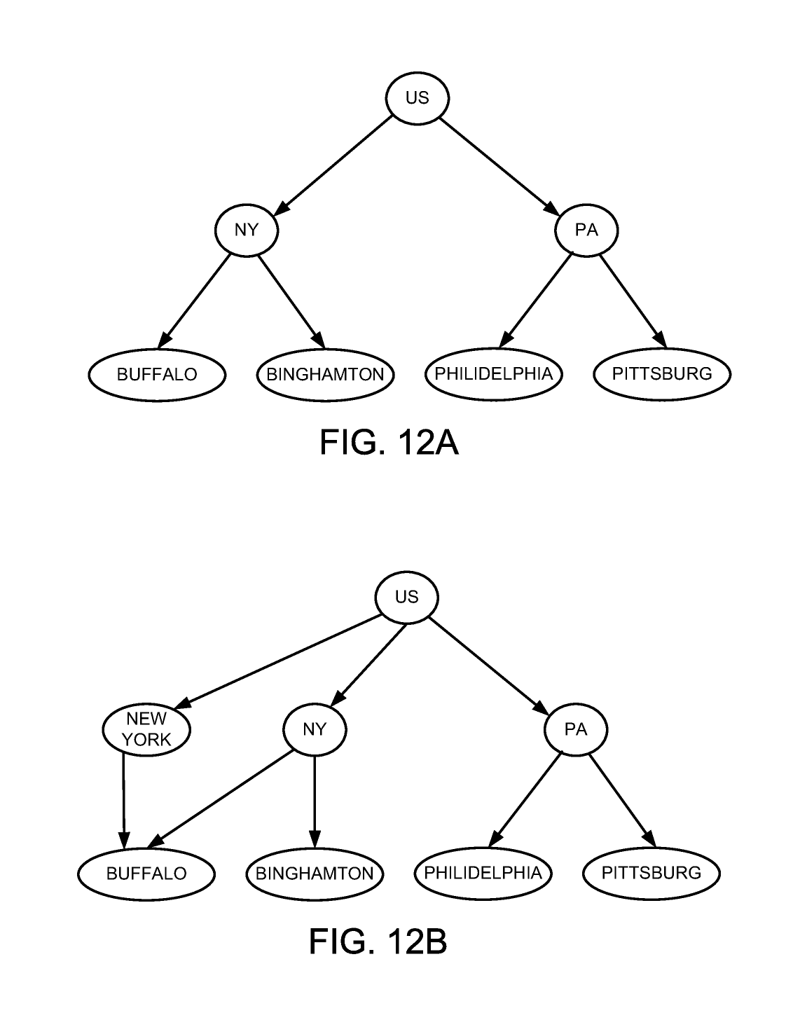

After data manipulation, the data dictionary may be utilized to describe the dimensions in the input data, as well as formulate the data's hierarchical arrangement (at 1006). The dimensions of descriptive data are not all expected to be orthogonal. Often, groups of 3-10 columns will represent a dimensional hierarchy. For example, three columns containing data for Country, State, City might form a region hierarchy. If the data adheres to this hierarchy cleanly, it might form a tree like that illustrated in FIG. 12A. Unfortunately, the data for columns in a dimensional hierarchy do not always form a proper hierarchical tree. Often, some elements of a child dimension will have more than one associated parent element. This is called a broken hierarchy. There are two typical causes for broken hierarchies. Inconsistent nominal element values are quite common. Due to possible inconsistent spelling, or data coming from disparate systems, the same conceptual value can have more than one nominal value. FIG. 12B is an example of a hierarchy where New York State is represented by both NY and New York in the data.

There can be valid reasons for broken hierarchies as well. For instance, the proper parent for an element might correctly change over time. If transactions from both time periods are included in a data set, then there would be two legitimately broken hierarchies. For example, assume a customer hierarchy of Customer, Bill-to Customer and Ship-to Customer, the customer may have had bills sent to their home office for a period of time, but over another period of time, try outsourcing accounts payable, and ask bills to go to a third party. As a result, the same Ship-to Customer may have two legitimate Bill-to Customers.

Continuing, the next step is to generate all possible ways of grouping transactions (at 1008). This formulation of groupings is done based upon the transaction's descriptive data. Next, a segment key system is developed (at 1010) which identifies the different segments. The transactions are then segmented according to the key system (at 1012). In doing so, a map can be set up associating each group of transactions with the unique dimensional values defining that group. The unique set of dimensional values defining that group is called the group key.

While transactions are being grouped, simultaneously the process may be applying statistical analysis of the segment. For example the percent margin the segment may be calculated, and with each transaction that is added to the segment, the percent margin value may be updated accordingly. For each group of transactions, the range across which the bulk of the transactions lay is determined, in terms of the decision variable. The bulk is defined as a provided percentage of the transactions. This analysis results in a range statistic for each group that includes the maximum and minimum and a threshold of the decision variable for that bulk of transactions from the group. In some embodiments, the threshold may be the mean of the segment statistic.

These statistics can be utilized to compare the segment against all ancestors (at 1014), and based upon the decision variable threshold, outlier segments may be identified as opportunities (at 1016). Each group has a distinct ancestry of larger groups that fully include the transactions in that group. The unique ancestry is generated for each group, which takes the form of a list of group keys. The list may be associated with the group key for which it is an ancestor. The range of each group is then compared to the decision variable threshold for the ancestors. If the ancestor threshold is above the maximum decision variable range for the segment, then an outlier may be identified. Likewise, if an ancestor threshold is above the minimum decision variable range for the segment, then there may be room for improving the decision variable value within the segment. After these outliers are identified, the process returns to FIG. 9, where the simple transaction analysis, intra-transaction analysis, and inter-transaction analysis is completed (at 920).

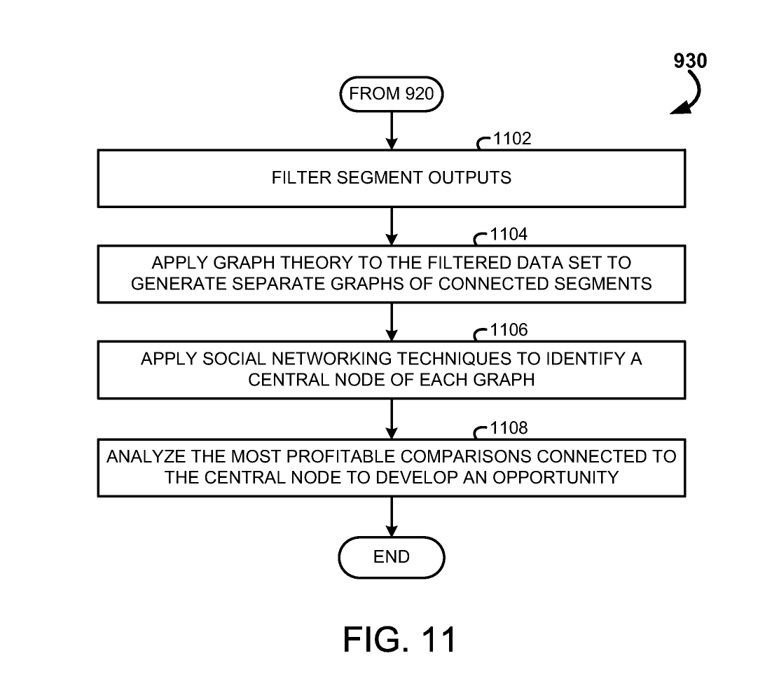

The various analysis results in a raw analytics dataset which has value in directing policies within a B2B price management system. Further, this data may be further leveraged by the segment comparer to analyze for segment comparisons (at 930). FIG. 11 provides this process in greater detail.

Here the segment outputs are filtered and pruned down to a reasonable base date set (at 1102). Graph theory is then applied generate separate graphs of connected segments (at 1104). This provides a first order classification of segments into non-overlapping spaces. Next, social networking techniques may be applied to the graphs to identify a central node of each graph (at 1106). The system then analyzes for the most profitable comparisons connected to that node to describe the opportunity discovered in that graph (at 1108). This ends the opportunity identifying process.

### III. EXAMPLES

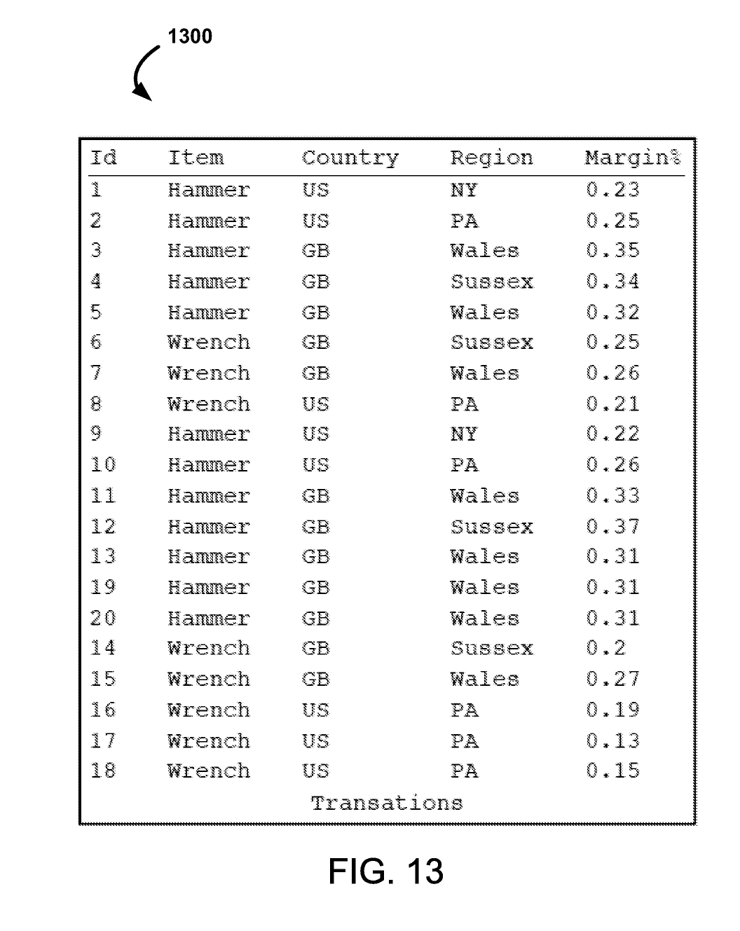

Now that the system architecture and processes have been disclosed in considerable detail, an example shall be provided to help illustrate the process using realistic data for clarification purposes. An initial data set is provided which includes transactions and associated data with each transactions. Errors may be corrected (such as negative volumes, nonsensical descriptors and the like). Additionally, the data may be manipulated/transformed to include desired metrics (such as the calculation of percent margins). FIG. 13 is an illustrative example of a set of transaction records 1300. Each transaction includes an ID, and item type, a country, region and a calculated margin percentage. In this example, an inter-transactional analysis of percent margin shall be illustrated. The results of the analysis is a rank ordered list of comparisons between statistics between related segments.

The relationship between the segments is described as ancestral, in that any segment that entirely contains another segment is an ancestor of the smaller segment. Take for instance the segments formed in this example by grouping the transactions by Item and Country simultaneously. One of the segments formed by such a grouping would have all transactions with both Hammer and US. This segment would have as an ancestor the segment containing all transactions whose Item is Hammers (including those in Great Britain as well). Another ancestor segment would be the segment containing all transactions whose Country is US (including transactions with Wrenches). A comparison between the child segment and its parent can produce an understanding of how that segment is performing within the larger group. Comparing margin percentage for the Hammer, US segment against the Hammer segment indicates how sales in the US compare to sales worldwide. Doing the same between the Hammer, US segment and the US segment indicates how within the US sales of Hammers compare against all tools.

For the sake of clarity, this disclosure will describe segments by a list of Dimension/Value pairs. So, the segment described as the one containing transactions having both an Item of Hammer and a Country of US would be simply described as {{Item, Hammer}, {Country, US}}. The ancestor segment containing transactions having a Country of US would be {{Country, US}}.

Another type of ancestral relationship exists as well. Imagine segmenting the transactions by Item and Region, such that one of the segments would be {{Item, Wrench}, {Region, NY}}. As in the previous discussion, ancestor segments of this segment would be both {{Item, Wrench}} and {{Region, NY}}. However, because Region is in a dimensional hierarchy, where Regions are within Countries, there is a hierarchical ancestor of this segment {{Item, Wrench}, {Country, US}}. A comparison of Margin % between these two segments indicates how sales of Wrenches are doing in terms of Margin % between NY and the rest of the US.

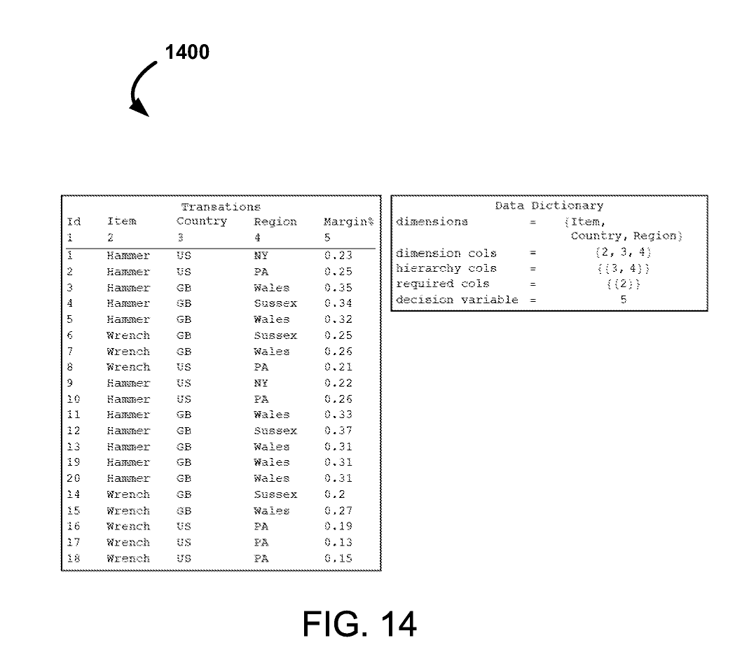

FIG. 14 is an illustrative example of the set of transaction records analyzed for percent margin and an applicable data dictionary shown at 1400. The data dictionary identifies the dimensions, the columns of the dimensions, the hierarchy relationships between the dimensions and the column index of the decision variable. In this example, the data dictionary indicates there is only one hierarchy relationship between the dimensions. This is a hierarchy between column 3 (Country) and column 4 (Region). Since column 4 comes after column 3 in the list, it indicates that Region is sub-ordinate to Country in the hierarchy. In general, there can be many hierarchies and many levels in each hierarchy.

The required columns, is a list of columns and/or hierarchies that must be included in every grouping. Some analyses do not make sense across different dimensions. A Margin Percentage analysis often does not make sense across more than one product or product family. For that reason, the comparisons can be limited by indicating the upper bounds on certain dimensions. What this means in a practical sense, is that every segment being compared, in this example, will include a value from column 2 (Item). Thus, in this example it is possible to get a comparison of {{Item, Hammer}, {Country, US}} to {{Item, Hammer}}, but not {{Item, Hammer}, {Country, US}} to {{Country, US}}.

From the description of the data found in the data dictionary, it can be determined that the data needs to be grouped in three different ways, by Item, by Item and Country, and by Item and Region. Notice any grouping that does not include an Item is missing, such as grouping by Country, Region or Country and Region. That is because of the requirement that Item be in every segment. Also notice that segmenting by Item and Country and Region is missing. That segment is redundant, since Country and Region are in a hierarchy. In a broken hierarchy this redundancy may not exist, in which case the non-redundant groupings may also be included.

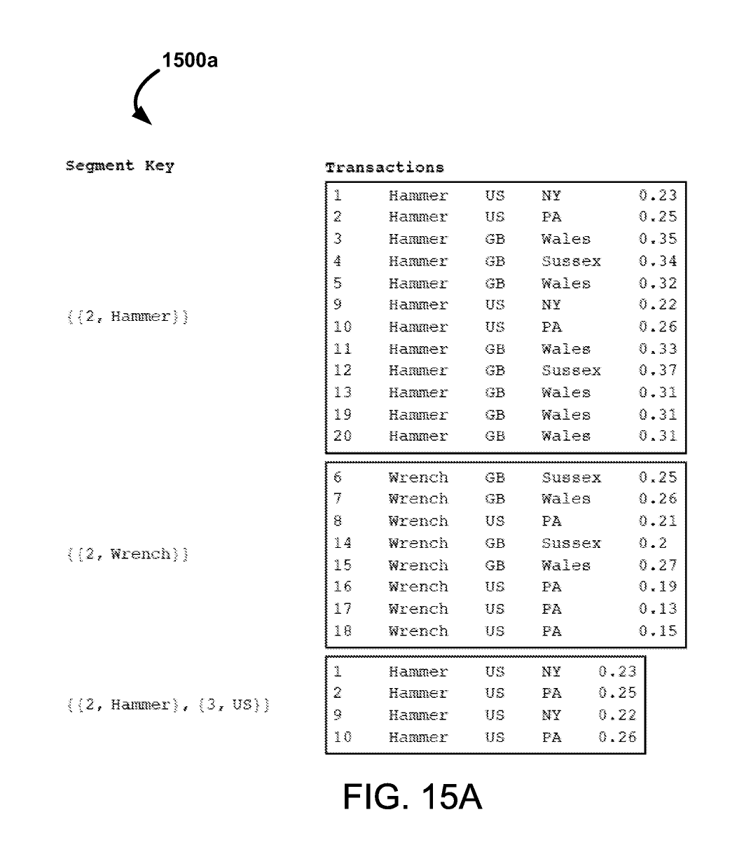

For the purposes of this example, the data is now grouped and then analyzed to allow for an orderly discussion. In some embodiments where clarity of discussion is not a priority, however, grouping and analysis may be performed simultaneously. Shown in FIGS. 15A and 15B are the transactions broken into segments identified by their segment key, at 1500a and 1500b respectively.

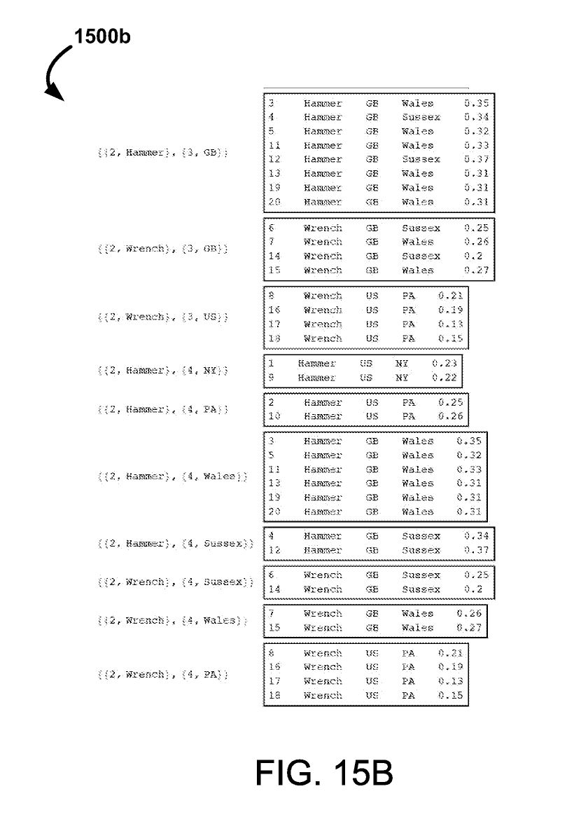

The analysis phase calculates a set of statistics for each segment. For the purpose of this example, we will find the length of each segment along with the 50th and 90th percentiles of the Margin % for the segment. FIG. 16 is a table of the results of that analysis, shown at 1600.

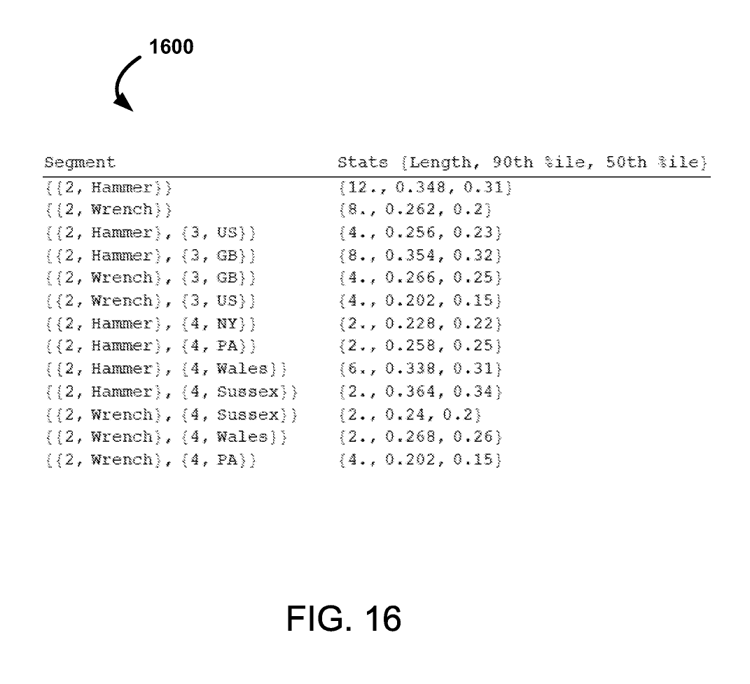

Before a segment can be compared to its ancestors, a way must be developed to determine the ancestors of a segment. A simple but expensive approach is twofold. First generate all the obvious ancestors by determining all of the possible subsets of the list of Dimension/Value pairs in each segment's key. FIG. 17 illustrates the segments and stats again, but this time, associated with each segment is a list of the segment keys of that segment's ancestor segments, at 1700.

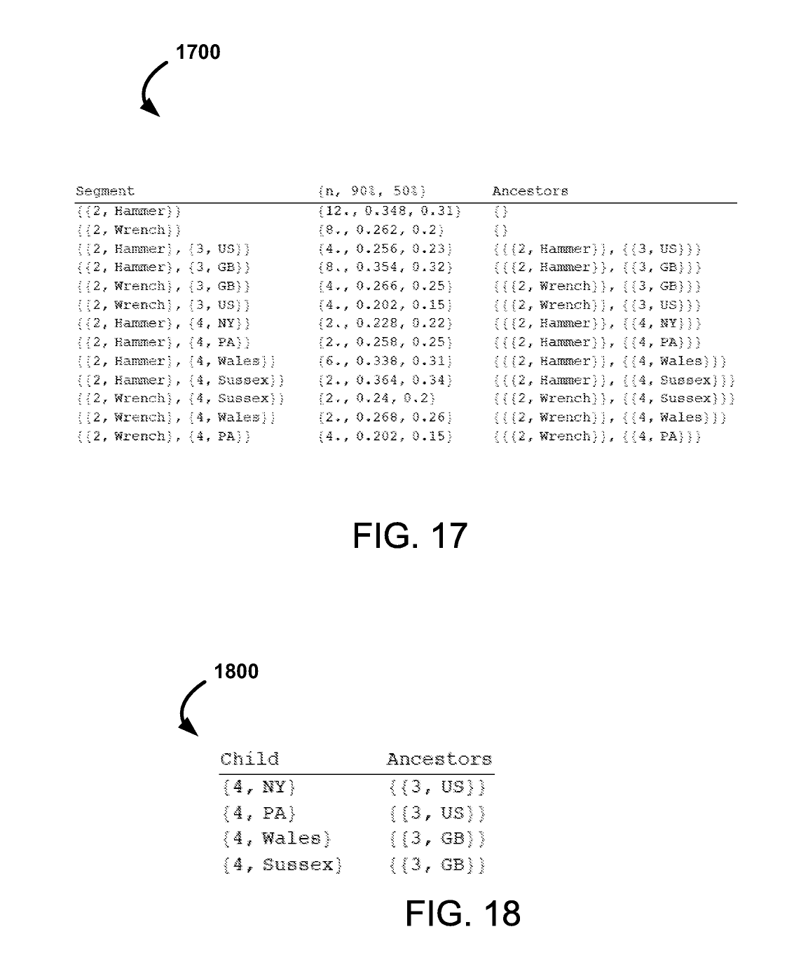

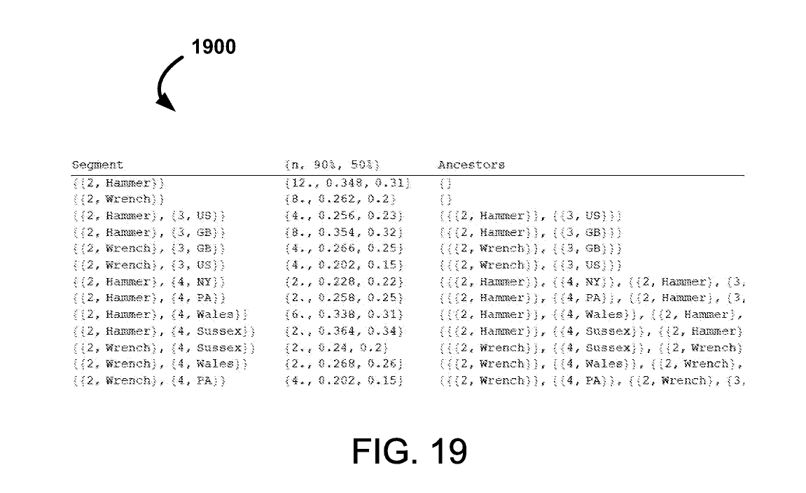

The ancestors illustrated in FIG. 17 are not complete, however. In this example the table does not include the ancestors of segments as a result of one or more of their elemental dimensions participating in a hierarchy. For instance, {{2, Hammer}, {4, NY} I above should have {{2, Hammer}, {3, US} I as an ancestor, and does not. It requires analysis of both the dimensional hierarchies, and the data itself, to determine these ancestors; for example, to know that {3, US} is an ancestor of {4, NY}. To accomplish this all possible elemental value hierarchies from the data are generated, as seen in FIG. 18 at 1800. Next these elemental key value hierarchies are applied to the data to expand the ancestors to form a complete set, as seen in FIG. 19, at 1900.

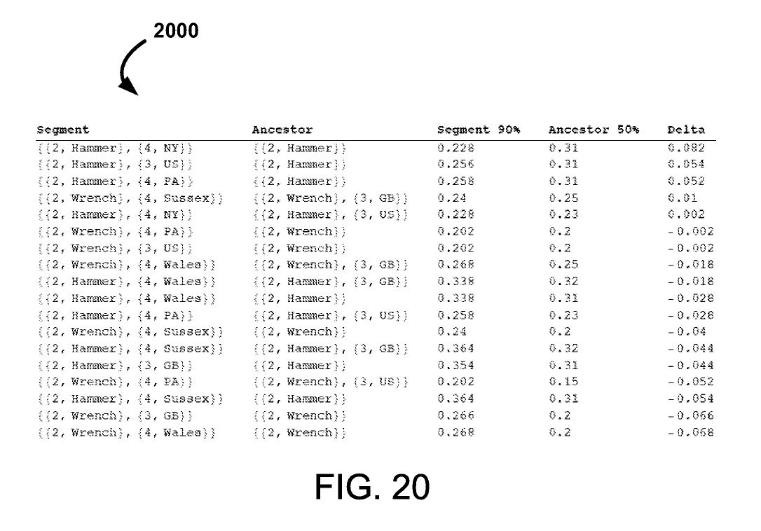

Now that the totality of a segment's ancestors are identified, each segment may be compared to the ancestor segment's statistics. The comparison of interest in these examples is the 90^{th} percentile of the margin percentage for the segment, and the 50^{th} percentile of the margin percentage for the ancestor segment. FIG. 20 is an illustrative example of each segment compared against its ancestor, shown at 2000.

The rank ordering of the segments by the largest delta indicates the segments that are under—performing by the most, in terms of margin percentage, by placing them at the top of the list. From such rankings opportunities and policy measures may be garnered in order to improve performance within these segments.

### IV. SYSTEM EMBODIMENTS

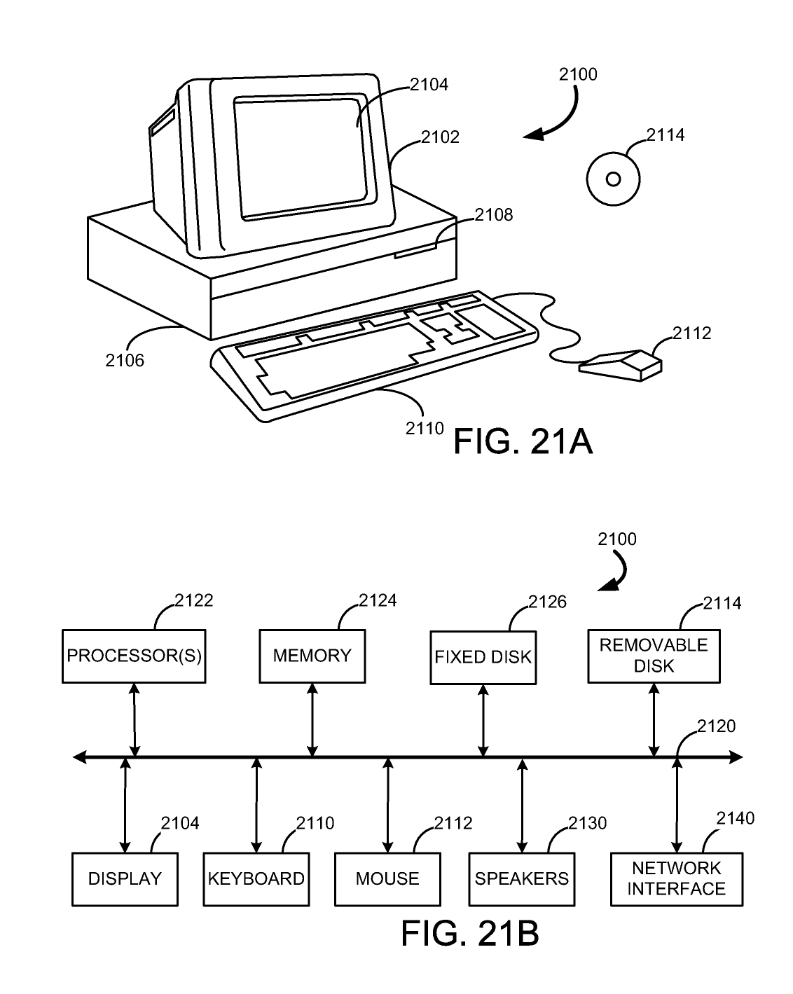

FIGS. 21A and 21B illustrate a Computer System 2100, which is suitable for implementing embodiments of the present invention. FIG. 21A shows one possible physical form of the Computer System 2100. Of course, the Computer System 2100 may have many physical forms ranging from a printed circuit board, an integrated circuit, and a small handheld device up to a huge super computer. Computer system 2100 may include a Monitor 2102, a Display 2104, a Housing 2106, a Disk Drive 2108, a Keyboard 2110, and a Mouse 2112. Disk 2114 is a computer-readable medium used to transfer data to and from Computer System 2100.

FIG. 21B is an example of a block diagram for Computer System 2100. Attached to System Bus 2120 are a wide variety of subsystems. Processor(s) 2122 (also referred to as central processing units, or CPUs) are coupled to storage devices, including Memory 2124. Memory 2124 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2126 may also be coupled bi-directionally to the Processor 2122; it provides additional data storage capacity and may also include any of the computer-readable media described below. Fixed Disk 2126 may be used to store programs, data, and the like and is typically a secondary storage medium (such as a hard disk) that is slower than primary storage. It will be appreciated that the information retained within Fixed Disk 2126 may, in appropriate cases, be incorporated in standard fashion as virtual memory in Memory 2124. Removable Disk 2114 may take the form of any of the computer-readable media described below.

Processor 2122 is also coupled to a variety of input/output devices, such as Display 2104, Keyboard 2110, Mouse 2112 and Speakers 2130. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2122 optionally may be coupled to another computer or telecommunications network using Network Interface 2140. With such a Network Interface 2140, it is contemplated that the Processor 2122 might receive information from the network, or might output information to the network in the course of performing the above-described multi-merchant tokenization. Furthermore, method embodiments of the present invention may execute solely upon Processor 2122 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, systems and methods for brute force traversal are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any of the methods disclosed is considered as disclosed by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for brute force traversal of a transaction data set, useful in association with an integrated price management system, the method comprising:
receiving a data dictionary that describes dimensions of transactions and hierarchical relationships between the dimensions;
generate possible combinations the transactions may be segmented;
generating a segmentation key for each of the possible combinations;
segmenting the transactions according to the key system;
calculating, by a processor, statistical metrics of at least one decision variable within each segment;
identifying the ancestor segments for each segment; and
comparing the statistical metrics of each segment to each of its ancestor segment's statistical metrics to identify outliers.

2. The method as recited in claim 1, wherein the segmenting and the calculating statistical metrics is performed in parallel.

3. The method as recited in claim 1, further comprising generating an estimate for the time to first results and time to completion.

4. The method as recited in claim 1, further comprising manipulating data in the transactions.

5. The method as recited in claim 4, wherein the manipulating includes generating a margin percentage for each transaction.

6. The method as recited in claim 1, wherein the ancestor segments are each segment that exists in a higher level of the hierarchical relationship.

7. The method as recited in claim 6, wherein the ancestor segments preclude redundant hierarchical levels.

8. The method as recited in claim 1, wherein the statistical metrics include a minimum, maximum and threshold for the at least one decision variable.

9. The method as recited in claim 8, wherein the outliers are identified where the threshold for the ancestor segment is below the minimum, or above the maximum, for the segment.

10. The method as recited in claim 8, wherein the threshold is approximately the 50^{th} percentile for the segment, and the maximum is approximately the 90^{th} percentile for the segment.

11. A system for brute force traversal of a transaction data set, useful in association with an integrated price management system, the method comprising:
a database containing a data dictionary that describes dimensions of transactions and hierarchical relationships between the dimensions;
a segmenter configured to generate possible combinations the transactions may be segmented, generate a segmentation key for each of the possible combinations, and segment the transactions according to the key system; and
an analyzer configured to calculate statistical metrics of at least one decision variable within each segment, identify the ancestor segments for each segment, and compare the statistical metrics of each segment to each of its ancestor segment's statistical metrics to identify outliers.

12. The system of claim 11, wherein the segmenter and the analyzer perform in parallel.

13. The system of claim 12, further comprising a priori estimator configured to generate an estimate for the time to first results and time to completion.

14. The system of claim 11, further comprising a data massager configured to manipulate data in the transactions.

15. The system of claim 14, wherein the manipulating includes generating a margin percentage for each transaction.

16. The system of claim 12, wherein the ancestor segments are each segment that exists in a higher level of the hierarchical relationship.

17. The system of claim 16, wherein the ancestor segments preclude redundant hierarchical levels.

18. The system of claim 12, wherein the statistical metrics include a minimum, maximum and threshold for the at least one decision variable.

19. The system of claim 18, wherein the outliers are identified where the threshold for the ancestor segment is below the minimum, or above the maximum, for the segment.

20. The system of claim 18, wherein the threshold is approximately the 50^{th} percentile for the segment, and the maximum is approximately the 90^{th} percentile for the segment.
